(19) United States
(12) Patent Application Publication
(10) Pub. No.: US 2025/0126382 A1
(43) Pub. Date: Apr. 17, 2025

(54) Audio Output Device

(71) Applicant: Yamaha Corporation, Hamamatsu-shi (JP)

(72) Inventor: Satriyo BAHARI, Gresik (ID)

(21) Appl. No.: 18/916,916

(22) Filed: Oct. 16, 2024

(30) Foreign Application Priority Data
Oct. 17, 2023 (JP) 2023-178737

(51) Int. Cl. H04R 1/02; H04R 1/40

(52) U.S. Cl. CPC H04R 1/026; H04R 1/403; H04R 2201/403

(57) ABSTRACT

An audio output device includes: a first surface, a second surface opposing the first surface, and a driver unit disposed therebetween. The first surface has a groove extending in an extension direction. The second surface includes a protrusion including a fixing portion provided at one end of the groove or between ends of the groove in the extension direction. When a first counterpart audio output device is stacked on the audio output device, the fixing portion is configured to fix a protrusion of the first counterpart audio output device. When the audio output device is stacked on a second counterpart audio output device, such that the protrusion engages a groove of the second counterpart audio output device, the protrusion is movable in the groove of the second counterpart audio output device to a fixing portion of the second counterpart audio output device.

### CROSS-REFERENCE TO RELATED APPLICATIONS

This application is based on and claims priority under 35 USC 119 from Japanese Patent Application No. 2023-178737 filed on Oct. 17, 2023, the contents of which are incorporated herein by reference.

### BACKGROUND

The present disclosure relates to an audio output device such as a line array speaker and a loudspeaker.

A line array speaker is an audio output device in which speakers serving as a sound source are vertically stacked and arranged in a straight line. The line array speaker can adjust the spread of sound in a vertical direction and emit sound to a target area by adjusting the sound emission direction of each speaker.

US2022/0321982A1 discloses a speaker mounting system configuring a line array speaker. In this speaker mounting system, a first speaker has upper connection points capable of being coupled to a support. Further, a second speaker has upper connection points capable of being coupled to lower connection points of the first speaker. According to this speaker mounting system, multiple speakers can be stacked in the form of a first speaker, a second speaker, . . . , thereby configuring a line array speaker.

### SUMMARY

However, in the line array speaker disclosed in US2022/0321982A1, it is necessary to place each of the speakers on the connection points while watching the connection points of the speaker. Therefore, it was difficult to easily assemble in a small number of people and in a short time.

The present disclosure has been made in view of the above circumstances, and an object thereof is to provide a technical means for facilitating the assembling of a line array speaker.

The present disclosure provides an audio output device including: a first surface; a second surface opposing the first surface; and a driver unit disposed between the first surface and the second surface, in which: the first surface has at least one groove extending in an extension direction, the second surface includes at least one protrusion, the audio output device allows a first counterpart audio output device to be stacked thereon and is stackable on a second counterpart audio output device, each of the first counterpart audio output device and the second counterpart audio output device includes at least one groove and at least one protrusion, the at least one groove of each of the first counterpart audio output device and the second counterpart audio output device having a same structure as that of the at least one groove of the audio output device, the at least one protrusion of each of the first counterpart audio output device and the second counterpart audio output device having a same structure as that of the at least one groove of the audio output device, the at least one groove includes a fixing portion provided at one end of the at least one groove or between ends of the at least one groove in the extension direction, the fixing portion is configured to fix at least one protrusion of the first counterpart audio output device when the first counterpart audio output device is stacked on the audio output device, and when the audio output device is stacked on the second counterpart audio output device such that the at least one protrusion of the audio output device engages at least one groove of the second counterpart audio output device, the at least one protrusion of the audio output device is movable in the at least one groove of the second counterpart audio output device to a fixing portion of the second counterpart audio output device.

### BRIEF DESCRIPTION OF THE DRAWINGS

The present disclosure will be described in detail based on the following without being limited thereto, wherein:

FIG. 1 is a side view showing a line array speaker configured by speakers, one of which serves as an embodiment of an audio output device;

FIG. 2 is a plan view of the speaker as viewed from above; and

FIG. 3 is a bottom view of the speaker as viewed from below.

### DETAILED DESCRIPTION

Hereinafter, an embodiment of the present disclosure will be described with reference to the drawings.

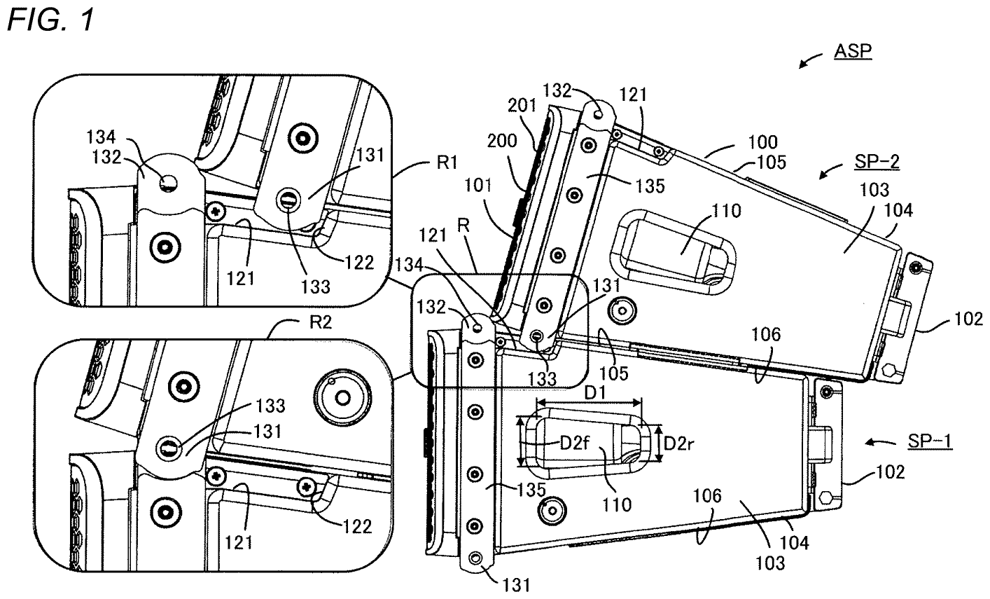

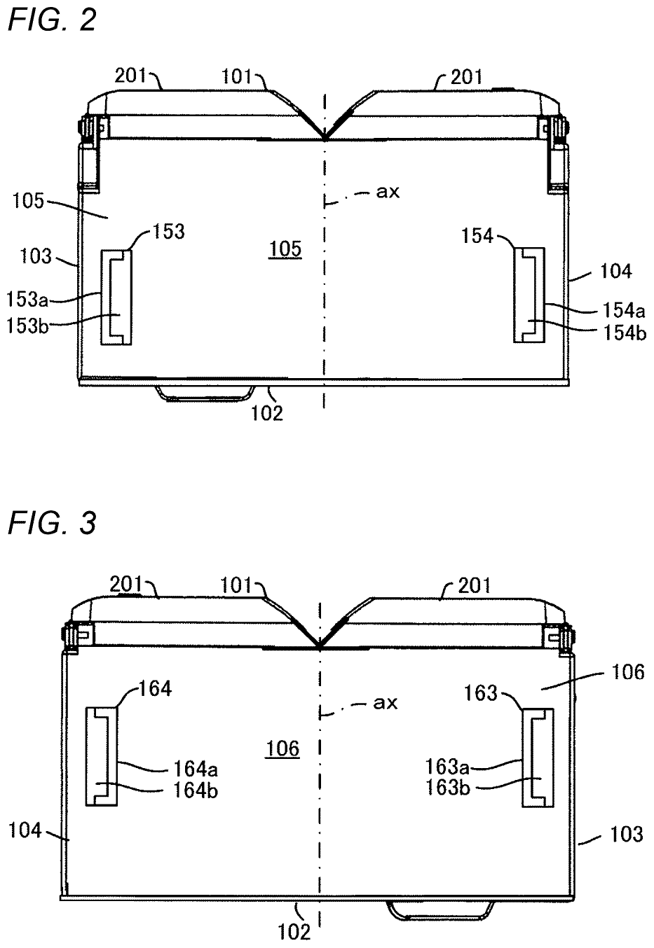

FIG. 1 is a side view showing a line array speaker ASP configured by speakers SP, and one of the speakers SP serves as an audio output device according to an embodiment of the present disclosure. In the embodiment, an audio output device allows a first counterpart audio output device to be stacked thereon and is stackable on a second counterpart audio output device. In FIG. 1, when the speaker SP-1 serves as the audio output device, the speaker SP-2 serves as the first counterpart audio output device, and when the speaker SP-2 serves as the audio output device, the speaker SP-1 serves as the second counterpart audio output device. In FIG. 1, the line array speaker ASP is configured by stacking two speakers SP-1, SP-2 in a vertical direction. The speakers SP-1, SP-2 have the same structure. Hereinafter, the speakers SP-1, SP-2 are collectively referred to as the speaker SP when there is no need to distinguish therebetween. The line array speaker ASP may be configured by three or more speakers SP. FIG. 2 is a plan view of the speaker SP as viewed from above. FIG. 3 is a bottom view of the speaker SP as viewed from below.

The speaker SP includes a housing 100 in which a driver unit 200 is incorporated. This housing 100 has a front surface 101 including two sound emission surfaces 201 on the left and right of the driver unit 200, a back surface 102 opposing the front surface 101, a first surface 105 and a second surface 106 extending in a front and rear direction of the speaker SP (i. e., the direction passing through the front surface 101 and the back surface 102) and sandwiching the driver unit 200 from both sides in the vertical direction, and a third surface 103 and a fourth surface 104 extending in the front and rear direction of the speaker SP and sandwiching the driver unit 200 from both sides in a horizontal direction. In this example, the upper surface of the housing 100 is the first surface 105, and the lower surface thereof is the second surface 106. In the speaker SP, the driver unit 200 is disposed between the first surface 105 and the second surface 106 opposing each other.

In each of the third surface 103 and the fourth surface 104, an elongated hole-shaped handgrip part 110 extending in the front and rear direction is provided at a center of the speaker SP in the vertical direction and a position on a slightly front side in the front and rear direction. This handgrip part 110 is a through hole formed in the side surfaces 103, 104, and has a shape and size that allows four fingers of an adult to be inserted therein. Specifically, the handgrip part 110 has a size D1 of 80 mm or more in the front and rear direction (the width of four fingers in a gripping state), sizes D2f, D2r of 10 mm or more in the vertical direction (the thickness of one finger), and a depth of an upper end wall of 10 mm or more. In addition, it is preferable that the size D2f on the front side in the vertical direction is longer than the size D2r on the rear side in the vertical direction. Further, in a preferred embodiment, the handgrip part 110, which is a through hole, communicates with a bass reflex port disposed within the housing 100. A user inserts the fingers of both hands into the handgrip parts 110 on the side surfaces 103, 104 to lift the upper speaker SP (for example, the speaker SP-2 in FIG. 1) and place the upper speaker SP on the lower speaker SP (for example, the speaker SP-1 in FIG. 1).

The speaker SP has a groove 121 extending in a predetermined extension direction on the first surface 105. In further detail, this extension direction is the front and rear direction of the speaker SP, and the speaker SP has two grooves 121 on the first surface 105 at the boundary with the third surface 103 and at the boundary with the fourth surface 104.

Further, the speaker SP has a protrusion 131 on the second surface 106. In further detail, an arm 135 extending in the vertical direction is fixed to the edges of the third surface 103 and the fourth surface 104 on the front surface 101 side by a fastener such as a bolt. This arm 135 has a lower end portion forming the protrusion 131 that protrudes downward from the second surface 106, and an upper end portion forming a fixing portion 132 that protrudes upward from the first surface 105. Here, the groove 121 described above is a means for guiding the protrusion 131 of the other speaker SP. Further, the fixing portion 132 is a means for fixing the protrusion 131 of the other speaker SP. The groove 121 described above extends from the fixing portion 132 toward the back surface 102 side. That is, the fixing portion 132 is located at one end of the groove 121 on the first surface 105.

In FIG. 1, when the speaker SP-2 is stacked on the other speaker SP-1, the protrusion 131 of the speaker SP-2 engages the groove 121 of the other speaker SP-1. The protrusion 131 of the speaker SP-2 slides along the groove 121 of the speaker SP-1. In this way, the protrusion 131 of the speaker SP-2 moves to the position of the fixing portion 132 of the speaker SP-1.

The groove 121 extends from the fixing portion 132 toward the back surface 102 to an end portion spaced by a predetermined distance. This end portion serves as a locking portion 122 that restricts the movement of the protrusion 131 in the back direction. It is preferable that the length from the fixing portion 132 to the locking portion 122 of the groove 121 is shorter than half the length from the fixing portion 132 to the back surface 102.

FIG. 1 shows an enlarged view of a first state R1 and a second state R2 of a region R in the vicinity of the fixing portion 132 of the speaker SP. The first state R1 refers to a state in which the protrusion 131 is separated from the fixing portion 132, and the second state R2 refers to a state in which the protrusion 131 reaches the position of the fixing portion 132. The protrusion 131 has a through hole 133 for attaching a release pin that can protrude inward in a width direction of the speaker SP. Further, the fixing portion 132 has a through hole 134 formed therein for storing the release pin. In the second state in which the protrusion 131 reaches the position of the fixing portion 132, when the release pin is inserted from the outside into the through hole 133 of the protrusion 131, the release pin is stored in the through hole 133 of the protrusion 131 and the through hole 134 of the fixing portion 132. In this way, the protrusion 131 is fixed to the fixing portion 132. Meanwhile, the release pin may be attached to the protrusion 131 or the fixing portion 132, and the protrusion 131 and the fixing portion 132 may be automatically fixed when the second state is reached.

As shown in FIG. 2, the first surface 105 has rectangular bottom sliders 153, 154 extending in the front and rear direction of the speaker SP. These bottom sliders 153, 154 are bilateral symmetrical with a center axis ax of the first surface 105 extending in the front and rear direction of the speaker SP as the axis of symmetry. Here, the bottom slider 153 includes a first protruding region 153a that has a predetermined protruding length from the first surface 105, and a second protruding region 153b that has a protruding length from the first surface 105 shorter than the first protruding region 153a. Similarly, the bottom slider 154 includes a first protruding region 154a that has a predetermined protruding length from the first surface 105, and a second protruding region 154b that has a protruding length from the first surface 105 shorter than the first protruding region 154a.

As shown in FIG. 3, the second surface 106 has rectangular top sliders 163, 164 extending in the front and rear direction of the speaker SP. These top sliders 163, 164 are bilateral symmetrical with a center axis ax of the second surface 106 extending in the front and rear direction of the speaker SP as the axis of symmetry. In the present embodiment, the center axis ax of the second surface 106 extending in the front and rear direction of the speaker SP and the center axis ax of the first surface 105 are located at the same position in the horizontal direction. The top sliders 163, 164 are bilateral symmetrical with the axis ax, which is the same as the axis of symmetry of the bottom sliders 153, 154, as the axis of symmetry. Further, the top sliders 163, 164 occupy the positions opposing the bottom sliders 153, 154 in the horizontal direction.

The top slider 163 includes a first protruding region 163a that has a predetermined protruding length from the second surface 106, and a second protruding region 163b that has a protruding length from the second surface 106 shorter than the first protruding region 163a. Similarly, the top slider 164 includes a first protruding region 164a that has a predetermined protruding length from the second surface 106, and a second protruding region 164b that has a protruding length from the second surface 106 shorter than the first protruding region 164a.

The bottom sliders 153, 154 and the top sliders 163, 164 serve to assist in positioning and relative movement of the upper speaker SP relative to the lower speaker SP. In further detail, in the present embodiment, when the speakers SP are stacked, the first protruding regions and the second protruding regions of the bottom sliders 153, 154 in the upper speaker SP come into contact with the first protruding regions and the second protruding regions of the top sliders 163, 164 in the lower speaker SP. Further, the upper speaker SP moves relative to the lower speaker SP while the first protruding regions and the second protruding regions thereof remain in contact with the first protruding regions and the second protruding regions of the lower speaker SP. In this way, in the present embodiment, the second surface 106 of the upper speaker SP does not come into direct contact with the first surface 105 of the lower speaker SP, so that the first surface 105 and the second surface 106 are not scratched.

In the present embodiment, when configuring the line array speaker ASP of FIG. 1, a user stacks the upper speaker SP-2 on the grooves 121 (two places on the left and right) of the lower speaker SP-1, and causes the protrusions 131 (two places on the left and right) of the upper speaker SP-2 to engage the grooves 121 (two places on the left and right) of the lower speaker SP-1.

At that time, the first protruding region 163a of the top slider 163 in the upper speaker SP-2 rests on the second protruding region 153b of the bottom slider 153 in the lower speaker SP-1. Further, the first protruding region 164a of the top slider 164 in the upper speaker SP-2 rests on the second protruding region 154b of the bottom slider 154 in the lower speaker SP-1. In this way, the top sliders 163, 164 and the bottom sliders 153, 154 assist in positioning the speaker SP-2 relative to the speaker SP-1, and the relative movement of the speaker SP-2 in the front and rear direction is guided.

Further, when a user pushes the upper speaker SP-2 forward while watching the groove 121 of the lower speaker SP-1, the protrusion 131 of the speaker SP-2 slides along the groove 121 and reaches the fixing portion 132 of the lower speaker SP-1. In this way, the release pin can be inserted from the through hole 133 of the protrusion 131 into the through hole 134 of the fixing portion 132, and the upper speaker SP-2 is fixed to the lower speaker SP-1.

As described above, the audio output device according to the present embodiment is the speaker SP in which the driver unit 200 is incorporated between the first surface 105 and the second surface 106 opposing each other, the speaker SP is stacked on the other speaker SP with the same structure, the first surface 105 has the groove 121 extending in a predetermined extension direction, the second surface 106 has the protrusion 131, and the groove 121 has the fixing portion 132 for fixing the protrusion 131 at one end in the extension direction. When the speaker SP is stacked on the other speaker SP, the protrusion 131 engages the groove 121 of the other speaker SP, and the protrusion 131 moves along the groove 121 to the fixing portion 132 of the other speaker SP. Therefore, according to the present embodiment, the speakers SP can be stacked to the extent that the speakers can be moved along the groove 121 to the fixing portion 132, instead of stacking the protrusions 131 only at one point on the fixing portion 132. As a result, the line array speaker can be easily assembled by a small number of people.

Although one embodiment of the present disclosure has been described above, other embodiments may be considered. For example, the following embodiments may be considered.

(1) The locking portion 122 may be omitted, and the groove 121 may extend to the back surface 102.

(2) In the above embodiment, the fixing portion 132 is provided at the position of the front end of the groove 121 (i.e., at the position of the front surface 101). However, the fixing portion 132 may be provided at a position in the middle of the groove 121.

(3) In the above embodiment, the first surface 105 is the upper surface of the housing 100, and the second surface 106 is the lower surface of the housing 100. However, the first surface 105 may be the lower surface of the housing 100, and the second surface 106 may be the upper surface of the housing 100. In this case, the groove 121 and the fixing portion 132 may be provided on the lower surface of the housing 100, which is the first surface 105, and the protrusion 131 may be provided on the upper surface of the housing 100, which is the second surface 106.

(4) In the above embodiment, the present disclose is applied to the speaker SP for configuring the line array speaker ASP. However, the present disclose may be applied to other loudspeakers or line array speaker.

(5) The bottom sliders 153, 154 and the top sliders 163, 164 may be omitted.

(6) In the above embodiment, the speakers SP-1, SP-2 have the same structure, but the present disclosure is not limited thereto. That is, it is not always necessary for the speakers SP-1, SP-2 to have the same structure entirely, and only a part of the structure of the speaker SP-1 may be the same as the corresponding part of the structure of the speaker SP-2. For example, only the structure of the groove 121 and the structure of the protrusion 131 of the speaker SP-1 may be the same as those of the speaker SP-2, and the structure of the other portion of the speaker SP-1 may be different from that of the speaker SP-2.

1. An audio output device comprising:
a first surface;
a second surface opposing the first surface; and
a driver unit disposed between the first surface and the second surface, wherein:
the first surface has at least one groove extending in an extension direction,
the second surface includes at least one protrusion,
the audio output device allows a first counterpart audio output device to be stacked thereon and is stackable on a second counterpart audio output device,
each of the first counterpart audio output device and the second counterpart audio output device includes at least one groove and at least one protrusion, the at least one groove of each of the first counterpart audio output device and the second counterpart audio output device having a same structure as that of the at least one groove of the audio output device, the at least one protrusion of each of the first counterpart audio output device and the second counterpart audio output device having a same structure as that of the at least one groove of the audio output device,
the at least one groove includes a fixing portion provided at one end of the at least one groove or between ends of the at least one groove in the extension direction,
the fixing portion is configured to fix at least one protrusion of the first counterpart audio output device when the first counterpart audio output device is stacked on the audio output device, and
when the audio output device is stacked on the second counterpart audio output device such that the at least one protrusion of the audio output device engages at least one groove of the second counterpart audio output device, the at least one protrusion of the audio output device is movable in the at least one groove of the second counterpart audio output device to a fixing portion of the second counterpart audio output device.

2. The audio output device according to claim 1, wherein the at least one groove includes a locking portion provided at a position away from the fixing portion, the locking portion being configured to restrict a movement of the at least one protrusion of the first counterpart audio output device.

3. The audio output device according to claim 1, wherein the first surface is an upper surface of the audio output device, and the second surface is a lower surface of the audio output device.

4. The audio output device according to claim 1, wherein the extension direction of the at least one groove is a front and rear direction of the audio output device.

5. The audio output device according to claim 4, further comprising:
a third surface and a fourth surface that sandwich the driver unit from both sides in a horizontal direction, wherein:
the at least one groove includes a first groove and a second groove, the first groove being formed in the first surface at a boundary with the third surface, the second groove being formed in the first surface at a boundary with the fourth surface, and
the at least one protrusion includes a first protrusion and a second protrusion, the first protrusion being formed in the second surface at a boundary with the third surface, the second protrusion being formed in the second surface at a boundary with the fourth surface.

6. The audio output device according to claim 5, wherein each of the third surface and the fourth surface comprises a handgrip part.

7. The audio output device according to claim 1, wherein the audio output device is a loudspeaker.

8. The audio output device according to claim 1, wherein the audio output device and at least one of the first counterpart audio output device and the second counterpart audio output device, when stacked, configure a line array speaker.

9. The audio output device according to claim 1, wherein the first counterpart audio output device and the second counterpart audio output device have a same structure as that of the audio output device.
